(19) United States
(12) Patent Application Publication
(10) Pub. No.: US 2013/0262196 A1
(43) Pub. Date: Oct. 3, 2013

(54) CONSOLIDATED PRESENTATION OF PHARMACEUTICAL INFORMATION FROM MULTIPLE SOURCES

(71) Applicant: Ronald R. Scalici, Essex Fells, NJ (US)

(72) Inventor: Ronald R. Scalici, Essex Fells, NJ (US)

(73) Assignee: PDI, INC., Parsippany, NJ (US)

(21) Appl. No.: 13/436,259

(22) Filed: Mar. 30, 2012

(51) Int. Cl. G06Q 30/00; G06Q 30/02

(52) U.S. Cl. 705/14.1; 705/26.61; 705/14.49

(57) ABSTRACT

Pharmaceutical marketing data from different pharmaceutical manufacturers may be integrated into a single system so that physicians may access the pharmaceutical marketing data from different manufacturers from a single application. Pharmaceutical company representatives may also be able to access and share the marketing data of different manufacturers with one or more physicians from a single application. Each pharmaceutical manufacturer may be able to specify which physicians and pharmaceutical company representatives are able to access the electronically stored pharmaceutical content.

### BACKGROUND

Pharmaceutical companies use sales representatives among other methods to market their pharmaceuticals to physicians. These representatives often conduct face-to-face meetings with physicians to provide information about pharmaceuticals and answer any questions the physician may have. However, since many physicians are busy attending to patients and performing other tasks, these meetings are often very quick and limited.

In an effort to make the most use of limited time, some pharmaceutical companies have created customized applications and/or links to specific web content for physicians that contain additional pharmaceutical information. These applications and links, however, are of limited benefit and usefulness. For example, if physicians want to access the application or linked content, they must first install the application or retrieve and then activate the link. Busy physicians do not want to spend their time installing applications and looking for links for each pharmaceutical product.

As described in detail below, we provide herein technology that enables pharmaceutical product and other marketing data from different pharmaceutical manufacturers to be integrated into a single system so that physicians may access the marketing data of different pharmaceutical manufacturers from a single application.

### BRIEF DESCRIPTION OF THE DRAWINGS

FIG. 1 shows a first exemplary process in an embodiment of the invention.

FIG. 2 shows an exemplary interfaces in an embodiment of the invention.

FIG. 3 shows a second exemplary process in an embodiment of the invention.

FIG. 4 shows an exemplary screen shot of displayed content items in an embodiment of the invention.

FIG. 5 shows an exemplary screen shot of a session log in an embodiment of the invention.

FIG. 6 shows an exemplary architecture in an embodiment of the invention.

### DETAILED DESCRIPTION

In an embodiment of the invention, pharmaceutical marketing data from different pharmaceutical manufacturers may be integrated into a single system. Physicians may be able to access the pharmaceutical marketing data from different manufacturers from a single application, instead of having to use different links or manufacturer specific applications to access pharmaceutical marketing data for each pharmaceutical product or from each manufacturer. Pharmaceutical company sales representatives may also be able to access and share the marketing data of different manufacturers with one or more physicians from a single application. The pharmaceutical marketing data may include the product label, specification sheets, usage or dosage instructions, promotional or instructional videos, side effect or warning notices, coupons, offers, and/or other electronically stored content approved by a pharmaceutical manufacturer relating to one or more pharmaceutical products.

Access to the data may be restricted to medical service providers, such as physicians, and pharmaceutical company sales representatives. Each pharmaceutical manufacturer may be able to specify which physicians and pharmaceutical company representatives are able to access the electronically stored pharmaceutical content provided by the pharmaceutical manufacturer. In some instances, the pharmaceutical manufacturer may specify the specific content items that each pharmaceutical company representative and/or physician may be able to access. In some instances, the pharmaceutical company representative may be able to select one or more content items for sharing with one or more physicians. Once a content item is selected for sharing by the pharmaceutical company representative, the physician may be granted access to the selected content item, if access had not been otherwise previously granted. A notification of the sharing of content may be sent to the physician or an application used by the physician to inform the physician of the new content item shared by the pharmaceutical company representative.

Aggregating pharmaceutical marketing data from different pharmaceutical manufacturers into a single application may enable the application to be used as a one-stop destination for physicians and pharmaceutical company representatives searching for pharmaceutical product information, making it more likely the application will be used by physicians and company representatives searching for pharmaceutical product information.

In some instances, physicians and pharmaceutical company representatives may be provided with different versions of the application presenting customized content for each user. For example, a physician may be provided with an application version that allows the physician to see: pharmaceutical company representatives assigned to the physician, pharmaceutical content items that the physician has been granted access to by a pharmaceutical manufacturer and/or a pharmaceutical company representative, promotional offers being offered by one or more pharmaceutical companies, and other useful information targeted for the physician.

The pharmaceutical company representative may, on the other hand, be provided with an application version that allows the pharmaceutical company representative to see: assigned physicians to the pharmaceutical company representative, physician profiles, upcoming appointments with physicians, and records of past appointments with physicians that may include records of specific topics discussed and/or content items shared with the physician. The application version provided to the pharmaceutical company representative may also include a sharing capability enabling the pharmaceutical company representative to share one or more pharmaceutical content items with a physician.

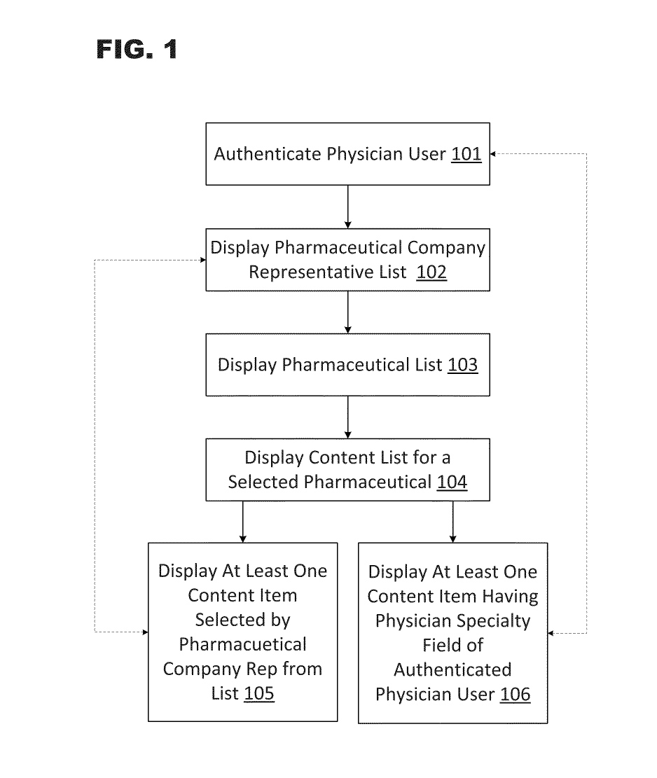

FIG. 1 shows a first exemplary process for providing targeted access to electronically stored pharmaceutical content. The process may be executed by a processing device from a set of instructions stored in a non-transitory computer readable medium. In box 101, a physician user may be authenticated at a first computing system. The physician user may be authenticated by providing a valid username and password or other verification of the physician user's identity.

For example, in some instances the authenticating of the physician user at the first computing system may be based on a comparing of physician identification information entered at the first computing system with National Plan and Provider Enumeration System information of physicians obtained from a National Provider Identifier registry at a second computing system. The physician user's identity may be verified when the entered physician identification information matches the National Plan and Provider Enumeration System information of physicians obtained from a National Provider Identifier registry. In other instances, other sources of physician identification data may be used. These other sources may include physician data maintained by one or more third parties, which may include one or more pharmaceutical manufacturers. For example, in some instances, a physician user may be prompted to identify their physician specialty during the authentication process.

The first computing system may be a computing system where the authentication is performed. For example, if the physician user is using a tablet or smart phone to access the pharmaceutical content and the authentication is performed through the tablet or smart phone, then the table or smart phone may be the first computing system.

In box 102, a list of selectable pharmaceutical company representatives assigned to the authenticated physician user may be displayed. The specific pharmaceutical company representative included in the displayed list may be obtained from a set of mappings provided by each pharmaceutical manufacturer that identify which pharmaceutical company representatives are assigned to which physicians. Thus, each physician may be only able to view those pharmaceutical company representatives that are assigned to the physician by at least one pharmaceutical company manufacturer. In other instances the physician may be provided with an option to search for and/or contact other pharmaceutical company representatives that not are assigned to the physician. The displayed list of pharmaceutical company representatives may include pharmaceutical company representatives representing at least two different pharmaceutical manufacturers.

In box 103, a list of selectable pharmaceutical products marketed by at least one of the pharmaceutical company representatives listed in box 102 may be displayed. The list of selectable pharmaceutical products may include at least two pharmaceutical products from at least two different pharmaceutical manufacturers. The specific pharmaceutical products included in the displayed list may be obtained from a set of mappings provided by each pharmaceutical manufacturer that identify which pharmaceutical products should be marketed to which physicians. The list of pharmaceutical products may include pharmaceutical products manufactured by two or more different pharmaceutical manufacturers. In some instances, an authenticated physician user may only be able to view those pharmaceutical products specifically associated with the physician in the mappings provided by each pharmaceutical manufacturer or obtained from another source. In other instances, a physician may be provided with an option to search for and/or add other pharmaceutical products that are not associated with the physician in the mappings.

In box 104, after the authenticated physician user makes a pharmaceutical product selection from the list of selectable pharmaceutical products, a list of selectable electronically stored content associated with the pharmaceutical product selection may be displayed. The displayed electronically stored content may include only content that has approved for disclosure to the authorized physician user by the pharmaceutical manufacturer. In some instances, each content item of the electronically stored content may be provided by a pharmaceutical manufacturer of the respective pharmaceutical product associated with the content item after the manufacturer has approved the content item.

A tamper detection function may be applied to each content item after approval by the manufacturer to detect subsequent tampering with content items. For example, each approved content item may be digitally signed or fingerprinted (such as by applying a hash function to the content, as one non-limiting example). The digital signature and/or fingerprint may later be used to verify and/or detect any subsequent changes to a content item. The tamper detection functions may be used to ensure that only authorized and approved content is distributed to health care professionals.

The electronically stored content list may include one or more promotional offers for the pharmaceutical product selected from the pharmaceutical product list. A promotional offer may include an offer for a sample quantity of the selected pharmaceutical product electronically redeemable by the authenticated physician user. If the authenticated physician user opts to select and electronically redeem the sample quantity offer, a redemption request may be transmitted over a communications network from a first computing system used by authenticated physician to a redemption authority responsible for fulfilling the sample quantity offer in order to redeem the offer.

A promotion offer may include an offer for a patient co-pay discount for the selected pharmaceutical product activatable by the authenticated physician user at the first computing system. If the authenticated physician user activates the patient co-pay discount offer at the first computing system, in some instances, the patient co-pay discount offer may be electronically transmitted over a communications network to a patient computing system, email account, data storage service, or device for the patient to subsequently access and redeem. In some instances, the patient co-pay discount offer may be electronically transmitted over a communications network to a computing system, email account, data storage service, or device used by a pharmaceutical dispensing entity. Once the co-pay discount offer has been received, the pharmaceutical dispensing entity may apply the patient co-pay discount offer to a patient co-payment.

In box 105, at least one content item designated by a pharmaceutical company representative from the list of pharmaceutical company representatives in box 102 may be specifically selected for inclusion in the displayed list of electronically stored content. In some instances the pharmaceutical company representative may select at least one content item for inclusion in the electronically stored content list. In other instances the pharmaceutical company representative may select each content item that is subsequently included in the electronically stored content list displayed to the authenticated physician user, except for content items designated for mandatory inclusion in the displayed electronically stored content list by a pharmaceutical manufacturer.

In box 106, at least one content item having a field identifying a same physician specialty as that of the authenticated physician user in box 101 may be specifically selected for inclusion in the displayed list of electronically stored content. For example, a list of electronically stored content displayed to an authenticated obstetrician user may include a content item relating to pharmaceutical product use/risks during pregnancy. On the other hand, a list of electronically stored content displayed to an authenticated allergist physician user may include a content item relating to known allergic reactions and drug interactions. In some instances, those content items having fields identifying different physician specialties than that of the authenticated physician user need not be displayed in the electronically stored content list.

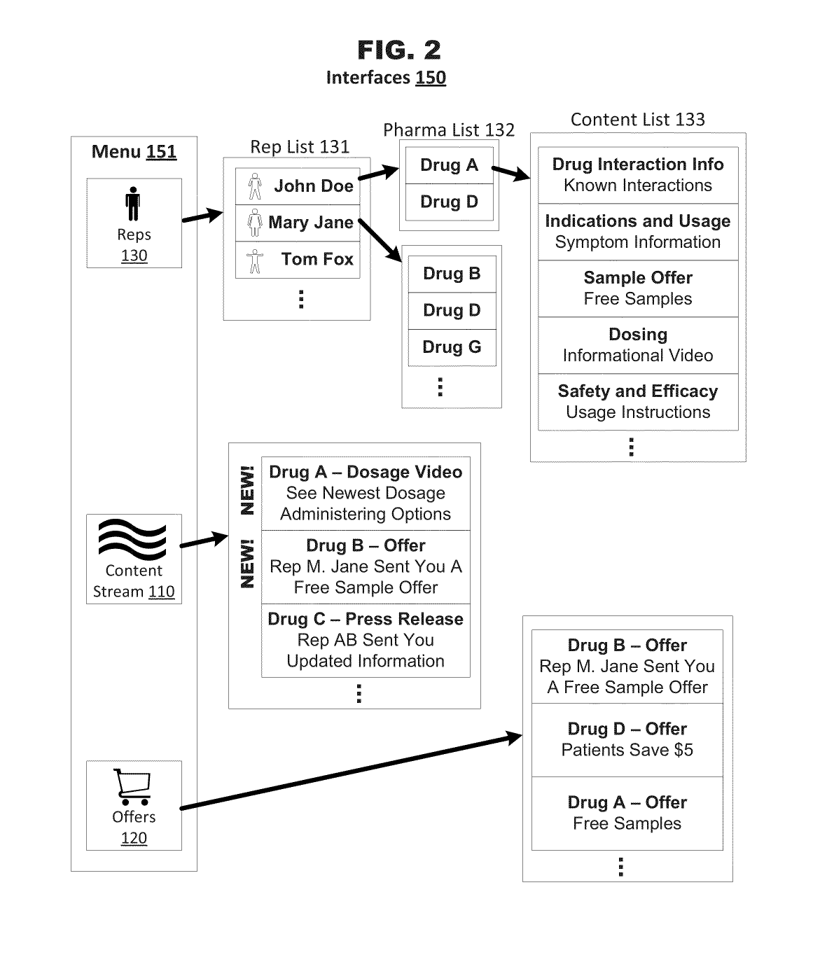

FIG. 2 shows an exemplary interfaces 150 that may be displayed to a physician in an embodiment. For example, once a physician has been authenticated, a first interface may be displayed showing menu screen 151 with different selectable options including a pharmaceutical representative list option 130, a content stream list option 110, and an offer list option 120.

If the physician chooses the representatives list option 130, a list of pharmaceutical company representatives 131 assigned to physician may be displayed. If the physician chooses a representative from the list, a list of pharmaceutical products 132 being marketed by the selected representative may be displayed. If the physician then chooses a pharmaceutical product, a list of content 133 designated as accessible to the physician may be displayed. If the physician then chooses a content item, the content item may be displayed, presented, enabled, or otherwise activated.

In other instances, different menu options 151 may be provided. For example, a pharmaceutical product list option may be included that shows a list of all pharmaceutical products that have at least one content item designated as accessible to the physician. Once the physician selects a pharmaceutical product from the list, additional information may be presented to the physician. For example, identification or contact information of the assigned pharmaceutical representative for the selected pharmaceutical product may be presented to the physician. A list of content items accessible to the physician for the selected pharmaceutical product may also be presented to the physician.

In other instances, a pharmaceutical manufacturer list option may be included that shows a list of all pharmaceutical manufacturers that have at least one content item designated as accessible to the physician. Once the physician selected a manufacturer, additional information may be presented to the physician. For example, a list of pharmaceutical products manufactured by the selected manufacturer that have at least one content item designated as accessible to the physician may be presented. If the physician then chooses a pharmaceutical product, a list of content 133 designated as accessible to the physician may be displayed.

In some instances, news or other information from or about the selected manufacturer may be presented. For example, a list of recent articles, press releases, or other data, such as tweets or informational tidbits disseminated by a third party may be shown. News or other information may also be presented in response to a physician making a selection from another menu or list. For example, in some instances if the physician selects a pharmaceutical product in a pharmaceutical product list, the news or other information about the selected pharmaceutical product may be presented to the physician. Similarly, if the physician selects a pharmaceutical company representative, the news or other information posted by the pharmaceutical company representative may be presented to the physician.

If the physician selects the content stream option 110 from the menu 151, then a chronological list of content items designated as accessible to the physician may be displayed. The content items may be added chronologically based on a date and/or time that the content item was designated as accessible to the physician. In some instances, a identifier, such as the word “NEW!,” may be added to one or more of the newest content items designated as accessible to the physician. In the example shown in FIG. 2, a dosage video for pharmaceutical “Drug A” was the content item most recently designated as accessible to the physician so it appears at the top of the content stream list. The offer for pharmaceutical “Drug B” was the next most recently accessible content item, so it appears below the dosage video for “Drug A.” The content stream may be updated in near real time or on a periodic or aperiodic basis. In some instances, content items may be designated as accessible immediately upon posting, though in other instances content items may be designated as accessible when the physician has been granted access to them.

If the physician selects the offer option 120, the physician may see a list of all available offers from each pharmaceutical manufacturer and/or pharmaceutical company representative. The offers may appear in some instances chronologically based on a date the offer was made to the physician. In some instances the offers sent to each physician may be customized based on information available to the pharmaceutical manufacturer and/or pharmaceutical company representative.

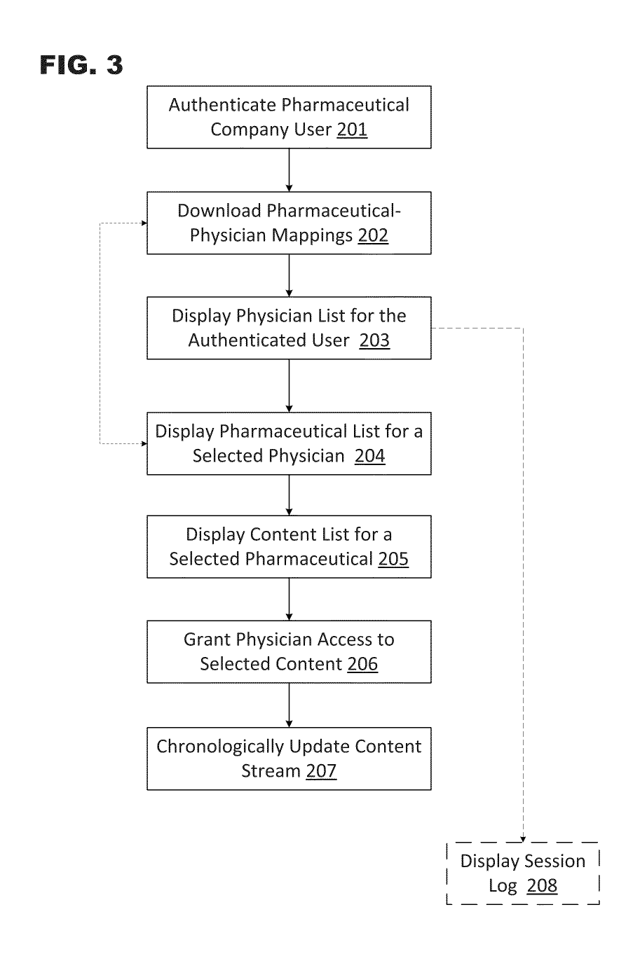

FIG. 3 shows a second exemplary process for providing targeted access to electronically stored pharmaceutical content. The process may be executed by a processing device from a set of instructions stored in a non-transitory computer readable medium. In box 201, a pharmaceutical representative user may be authenticated at a first computing system. The pharmaceutical representative user may be a sales, marketing, or other representative acting on behalf of a pharmaceutical manufacturer. The pharmaceutical representative user may be authenticated by providing a valid username and password or other form of verification of the pharmaceutical representative user's identity.

Data used to authenticate the pharmaceutical representative user may originate from one or more sources. These sources may include pharmaceutical representative data maintained by one or more third parties, which may include one or more pharmaceutical manufacturers.

The first computing system may be a computing system where the authentication is performed. For example, if the pharmaceutical representative user is using a tablet, smart phone, or other mobile device, and the authentication is performed through the tablet, smart phone, or other mobile device, then the table, smart phone, or other mobile device may be the first computing system.

In box 202, pharmaceutical-physician mappings for each physician assigned to the authenticated pharmaceutical representative user may be downloaded from a second computing system through a communications network. The pharmaceutical-physician mappings may identify which pharmaceutical products are being marketed to which physicians and vice versa. The pharmaceutical-physician mappings may be provided by a manufacturer of each pharmaceutical product or other entity to focus marketing resources on particular pharmaceutical products and/or particular physicians.

In box 203, a list of selectable physicians assigned to the pharmaceutical representative user for pharmaceutical marketing purposes may be displayed. In some instances, each pharmaceutical manufacturer may assign pharmaceutical representative users to physicians, though in other instances the pharmaceutical representative users may be assigned to physicians by others or in other ways, such as by geographic proximity. These assignments may be used to generate the displayed list of selectable physicians for each pharmaceutical representative user.

In box 204, once the pharmaceutical representative user has selected a physician, a list of selectable pharmaceutical products associated with the selected physician according to the downloaded pharmaceutical-physician mappings may be displayed. The downloaded pharmaceutical-physician mappings may be used to identify each of the pharmaceutical products associated with the selected physician and then determine which pharmaceutical product is included in the displayed list of selectable pharmaceutical products.

In box 205, once the pharmaceutical representative user has selected a pharmaceutical product from the displayed list of selectable pharmaceutical products, a list of selectable electronically stored content associated with the selected pharmaceutical product may be displayed. The electronically stored content may include marketing brochures, pamphlets, press releases, media articles, reviews, videos, promotional offers, and other informational or marketing content related to the selected pharmaceutical product.

In some instances, once the pharmaceutical representative user has selected a pharmaceutical product from the displayed list of pharmaceutical products, a list of promotional offers for the selected pharmaceutical product may be included in and displayed as part of the electronically stored content list. As discussed previously, a promotional offer may include, but is not limited to, an offer for a sample quantity of the selected pharmaceutical product or an offer for a patient co-pay discount for the selected pharmaceutical product. Other promotion offers may include other discounts, coupons, or rebates.

Once the pharmaceutical representative user has selected a promotion offer from the list, the selected physician may be granted access to the selected offer at the third computing system. The content stream viewable by the selected physician at the third computing system may be chronologically updated to indicate that access to the selected promotional offer has been granted. This chronological updating may be based on a time that the access to the selected promotional offer was granted to the selected physician.

In box 206, once the pharmaceutical representative user has selected one or more content items in the list of electronically stored content, the physician previously selected by the pharmaceutical representative user may be granted access to the selected content at a third computing system used by the selected physician to access the electronically stored content. The third computing system may be a computing system, such as a computer, smart phone, or tablet used by the physician to access the electronically stored content whereas the first computing system may be a different computing system used by the pharmaceutical representative user to market the pharmaceutical products.

In box 207 a content stream viewable by the selected physician may be chronologically updated at the third computing system with an indication that access to the selected electronically stored content has been granted. The chronological updating of the content stream may occur based on a time that access to the selected electronically stored content was granted to the selected physician. The content stream may show a list of new content available to the selected physician at the third computing system used by the selected physician in real time or near real time as the content is made available. In other instances the content stream may show updated content in a periodic or aperiodic basis instead of in near real time.

In box 208, a session log of meetings between a physician selected from the displayed physician list in box 203 and the pharmaceutical representative user may be displayed. The session log may identify a pharmaceutical product from the pharmaceutical products list in box 204 discussed with the selected physician in box 203 at each logged meeting. The session log may identify the selected electronically stored content that the selected physician was shown or granted access to at each logged meeting.

In some instances, the session log may also include, for each logged meeting, an indication of whether the selected physician was able to meet with the pharmaceutical representative user, a duration of the meeting, a rating of a level of access to a staff of the selected physician, and a rating of a level of access to the selected physician.

An average rating of different pharmaceutical representative users' reported level of access to the staff of the selected physician may be calculated using information in different session logs of meetings between the selected physician and the different pharmaceutical representative users.

An average rating of different pharmaceutical representative users' reported level of access to the selected physician may be calculated using information in different session logs of meetings between the selected physician and the different pharmaceutical representative users.

The calculated average ratings may be designated as overall engagement ratings for the accessibility of staff of the selected physician and the selected physician.

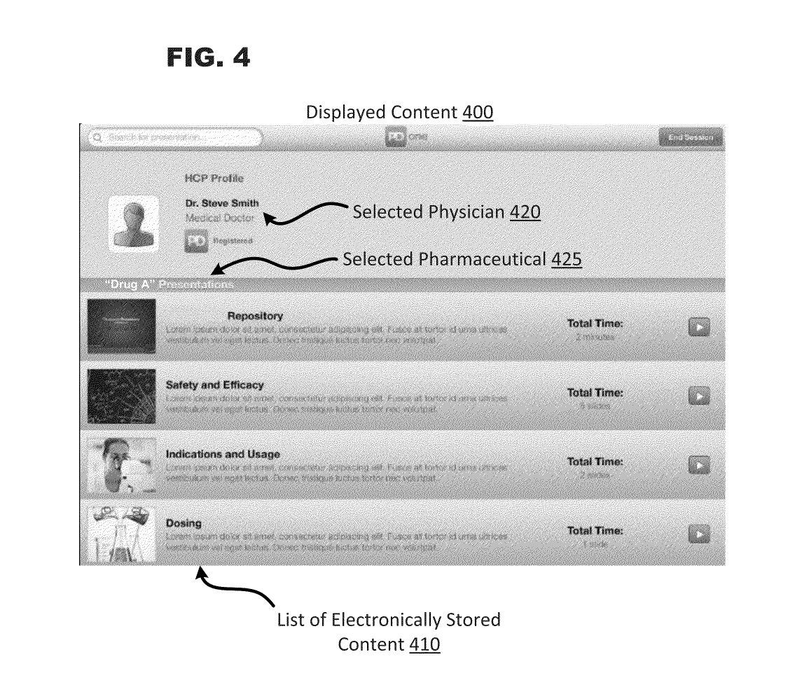

FIG. 4 shows an exemplary screen shot of content items that may be displayed to a physician or pharmaceutical company representative. The displayed content 400 may include an identifier of a physician 420 and/or a selected pharmaceutical product 425. A list of electronically stored content 410 accessible to the identified physician 420 and/or pertaining to the selected pharmaceutical product 425 may then be displayed. The physician and/or pharmaceutical company representative may then select a content item in the list 410 to view, download, enable, or otherwise activate the selected content item. The pharmaceutical company representative may also select a content item to share the content item with a physician and/or make the content item accessible to a physician.

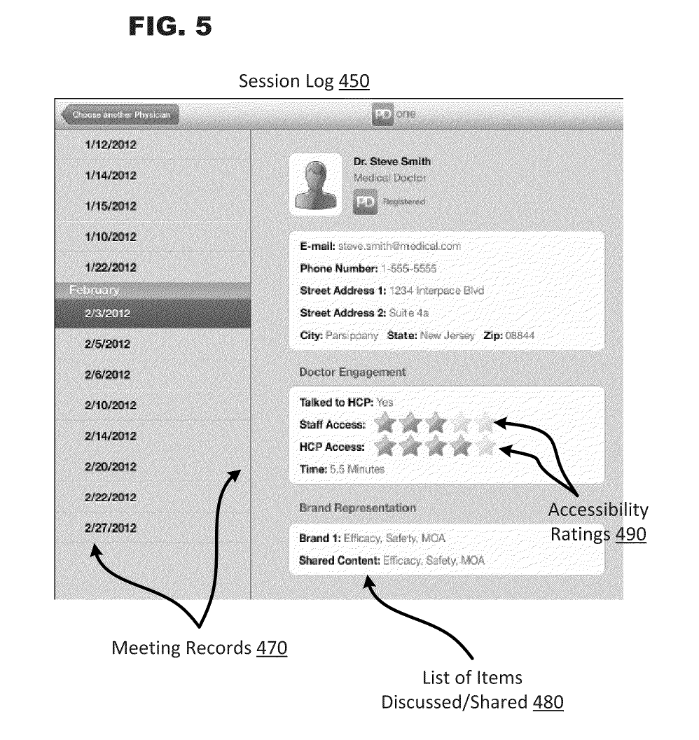

FIG. 5 shows an exemplary screen shot of a session log 450 of a pharmaceutical representative user viewing records 470 of meetings with a hypothetical doctor Steve Smith. The session log 450 may be used to keep records 470 of each meeting between a physician and a pharmaceutical representative user. The session log may identify items or topics 480 that the pharmaceutical representative user discussed or shared with the physician at each logged meeting. The session log may also include, for each logged meeting, an indication of whether the selected physician was able to meet with the pharmaceutical representative user, a duration of the meeting, and one or more ratings 490 of a level of access to the physician and/or a staff of the physician.

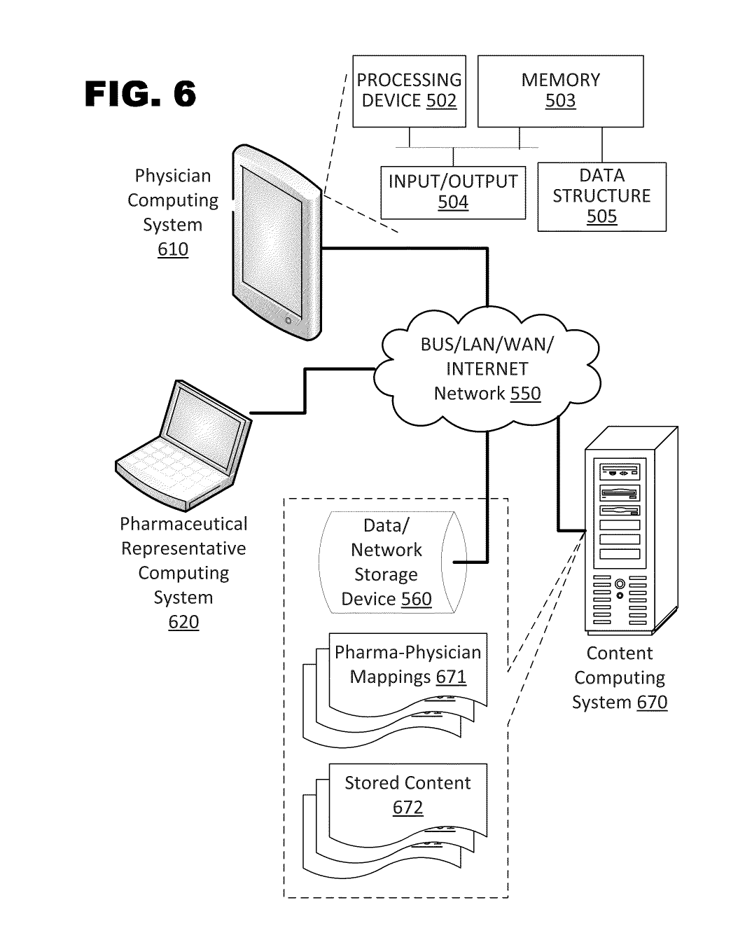

FIG. 6 shows an exemplary architecture. A physician computing system 610, pharmaceutical company representative computing system 620 and content computing system 670 may be connected to a communications network 550 to enable a transfer of data between one or more of the systems 610, 620, and 670. Communications network 550 may include a LAN, WAN, bus, or the Internet.

The physician computing system 610 may be used by a physician to access the pharmaceutical product and other information discussed herein. The pharmaceutical company representative computing system 620 may be used by the pharmaceutical company representative to access the pharmaceutical product and other information discussed herein, share information with one or more physicians, and/or view or enter session log information relating to meetings with physicians. Each of the computing systems 610, 620, and 670 may include any type of computing system, including, but not limited to, laptops, smart phones, and tablets.

The content computing system 670 may be used to store data include pharmaceutical-physician mappings 671, electronically stored content 672 including pharmaceutical content provided by one or more pharmaceutical manufacturers, physician information, pharmaceutical representative information, pharmaceutical product information, session logs of meeting between pharmaceutical representatives and physicians, promotion offers, press releases and other information. The mappings 671, electronically stored content 672, and other stored information may be stored on a data or network storage device 560.

In some embodiments the storage device 560 may also be separate from the content computing system 670 but connected to it through network 550. The storage device 560 may contain a hard disk drive, flash memory, or other computer readable media capable of storing data. Other external systems and data sources may also be connected to network 550. These other systems may be used to supply additional data or information used by the physician, pharmaceutical representative, or content computing systems 610, 620, and 670.

In some instances, the data stored in the content computing system 670 may shared, streamed, sent, and/or transferred to the physician computing system 610 and/or pharmaceutical company representative computing system 620 on demand each time the data is requested. In some instances, the data stored in the content computing system 670 may downloaded to the physician computing system 610 and/or pharmaceutical company representative computing system 620. The downloading may occur in some instances when the information is first requested or as part of an application installation or update.

Each of the systems, clients, and devices in FIG. 6 may contain a processing device 502, memory 503 storing loaded data or a loaded data structure 505, and a communications device 504, all of which may be interconnected via a system bus. In various embodiments, each of the systems 610, 620, and 670 may have an architecture with modular hardware and/or software systems that include additional and/or different systems communicating through one or more networks.

Communications device 504 may enable connectivity between the processing devices 502 in each of the systems 610, 620, and 670 and the network 550 by encoding data to be sent from the processing device 502 to another system over the network 550 and decoding data received from another system over the network 550 for the processing device 502.

In an embodiment, memory 503 may contain different components for retrieving, presenting, changing, and saving data and may include a computer readable medium. A computer readable medium and/or memory 503 may include a variety of memory devices, for example, Dynamic Random Access Memory (DRAM), Static RAM (SRAM), flash memory, cache memory, and other memory devices. Additionally, for example, memory 503 and processing device(s) 502 may be distributed across several different computers that collectively comprise a system.

Processing device 502 may perform computation and control functions of a system and comprises a suitable central processing unit (CPU). Processing device 502 may include a single integrated circuit, such as a microprocessing device, or may include any suitable number of integrated circuit devices and/or circuit boards working in cooperation to accomplish the functions of a processing device. Processing device 502 may execute computer programs, such as object-oriented computer programs, within memory 503.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, although the physician computing system 610 is shown as a separate system from the pharmaceutical representative computing system 620, in some instances the physician and the pharmaceutical representative may use a single computing system.

Additionally, while the description refers to the pharmaceutical industry in particular, different embodiments may be applied to other areas of medical industry as well. For example, medical device manufacturers, their sales representatives, and/or their products, may also be included in different embodiments either in addition to or instead of the pharmaceutical manufacturers and their sales representatives and pharmaceutical products. Thus, in an embodiment, a physician may be able to access content relating to one or more medical devices, such as surgical devices, testing kits, orthopedic devices, and so on, in addition to or instead of accessing content relating to pharmaceutical products. As another example, biotechnology companies, their sales representative, and/or their biotech offerings may be included in an embodiment either in addition to or instead of the pharmaceutical manufacturers and their sales representatives and pharmaceutical products. In this case, the physician may be able to access content relating to one or more biotech company offerings, in addition to or instead of accessing content relating to pharmaceutical products. Thus, different embodiments may be applied to different areas of medical industry.

In some instances electronically stored content from different areas of the medical industry may be associated with or linked to other content that is being presented to physician. For example, if a physician selects a particular product, for example selecting insulin from a list of pharmaceutical products, then the electronically stored content provided to the physician may include not just content about the selected product, but may also include content about other products related to the selected product, such as, in the case of insulin, additional content items relating to glucose testing kits. This additional content information may be provided or approved by the manufacturer of the product originally selected by the physician or it may originate from another source.

We claim:

1. A method for providing targeted access to electronically stored pharmaceutical content comprising:
authenticating a physician user at a first computing system;
displaying a list of selectable pharmaceutical company representatives assigned to the authenticated physician user;
displaying a list of selectable pharmaceutical products from different pharmaceutical manufacturers marketed by at least one of the pharmaceutical company representatives to the authenticated physician user;
responsive to a pharmaceutical product selection, displaying a list of selectable electronically stored content approved for disclosure to the authorized physician user that is associated with the pharmaceutical product selection,
wherein, the electronically stored content list includes: (i) at least one content item selected for inclusion by a pharmaceutical company representative in the displayed list of pharmaceutical company representatives, (ii) at least one content item having a field identifying a physician specialty of the authenticated physician user, and (iii) at least one content item obtained from a second computing system over a communications network.

2. The method of claim 1, wherein the authenticating of the physician user at the first computing system is based on a comparing of physician identification information entered at the first computing system with National Plan and Provider Enumeration System information of physicians obtained from a National Provider Identifier registry at a second computing system.

3. The method of claim 1, wherein the authenticated physician user identifies their physician specialty as part of the authenticating of the physician user.

4. The method of claim 1, wherein each content item of the electronically stored content is provided or approved by a manufacturer of a respective pharmaceutical product associated with the content item after approval by the manufacturer.

5. The method of claim 4, further comprising applying a tamper detection function to each content item after approval by the manufacturer to detect subsequent tampering with each content item.

6. The method of claim 4, wherein the displayed pharmaceutical company representatives list and the displayed pharmaceutical products list are obtained from a set of mappings provided by each pharmaceutical manufacturer that identify which pharmaceutical company representatives are assigned to which physicians and that identify which pharmaceutical products are marketed to which physicians.

7. The method of claim 1, wherein content items having fields identifying different physician specialties than that of the authenticated physician user are not displayed in the electronically stored content list.

8. The method of claim 1, wherein the displayed pharmaceutical company representatives list includes pharmaceutical company representatives representing a plurality of pharmaceutical manufacturers and the pharmaceutical products list includes pharmaceutical products manufactured by the plurality of pharmaceutical manufacturers.

9. The method of claim 1, wherein the pharmaceutical company representative in the pharmaceutical company representatives list selecting the at least one content item for inclusion in the electronically stored content list is able to select each content item included in said electronically stored content list except for content items designated for mandatory inclusion in said electronically stored content list by a pharmaceutical manufacturer.

10. The method of claim 1, wherein the electronically stored content list includes a promotional offer for the selected pharmaceutical product.

11. The method of claim 10, wherein the promotional offer is an offer for a sample quantity of the selected pharmaceutical product electronically redeemable by the authenticated physician user at the first computing system and further comprising transmitting a redemption request from the authenticated physician user over a communications network to a redemption authority responsible for fulfilling the sample quantity offer to redeem the sample quantity offer.

12. The method of claim 10, wherein the selected promotional offer is an offer for a patient co-pay discount for the selected pharmaceutical activatable by the authenticated physician user at the first computing system and further comprising:
responsive to an activation of the patient co-pay discount offer, electronically transmitting the patient co-pay discount offer to a patient for the patient to redeem.

13. The method of claim 10, wherein the selected promotional offer is an offer for a patient co-pay discount for the selected pharmaceutical product activatable by the authenticated physician user at the first computing system and further comprising:
responsive to an activation of the patient co-pay discount offer, electronically transmitting the patient co-pay discount offer to a pharmaceutical dispensing entity, wherein the pharmaceutical dispensing entity applies the patient co-pay discount offer to a patient co-payment.

14. A non-transitory computer readable medium storing instructions that, when executed by a processing device, cause the processing device to:
authenticate a physician user;
display a list of selectable pharmaceutical company representatives assigned to the authenticated physician user;
display a list of selectable pharmaceutical products from different pharmaceutical manufacturers marketed by at least one of the pharmaceutical company representatives to the authenticated physician user;
responsive to a pharmaceutical product selection, display a list of selectable electronically stored content approved for disclosure to the authorized physician user that is associated with the pharmaceutical product selection,
wherein, the electronically stored content list includes: (i) at least one content item selected for inclusion by a pharmaceutical company representative in the displayed list of pharmaceutical company representatives and (ii) at least one content item having a field identifying a physician specialty of the authenticated physician user.

15. A method for providing targeted access to electronically stored pharmaceutical content comprising:
authenticating a pharmaceutical representative user at a first computing system;
downloading, from a second computing system through a communications network, pharmaceutical-physician mappings for each physician assigned to the pharmaceutical representative user;
displaying a list of selectable physicians assigned to the pharmaceutical representative user;
responsive to a physician selection, displaying a list of selectable pharmaceutical products associated with the selected physician according to the downloaded pharmaceutical-physician mappings;
responsive to a pharmaceutical product selection, displaying a list of selectable electronically stored content associated with the pharmaceutical product selection;
responsive to an electronically stored content selection, granting the selected physician access to the selected electronically stored content at a third computing system used by the selected physician for accessing the electronically stored content selection; and
chronologically updating a content stream viewable by the selected physician at the third computing system with an indication of the granting of access to the electronically stored content selection based on a time of the granting of said access to the selected electronically stored content.

16. The method of claim 15, further comprising:
responsive to the pharmaceutical product selection, displaying a list of selectable promotional offers for the selected pharmaceutical product as part of the electronically stored content list;
responsive to a promotion offer selection, granting the selected physician access to the selected promotion offer at the third computing system; and
chronologically updating the content stream viewable by the selected physician at the third computing system with an indication of the granting of access to the selected promotional offer based on a time of the granting of said access to the selected promotional offer.

17. The method of claim 16, wherein the selected promotional offer is an offer for a sample quantity of the selected pharmaceutical product.

18. The method of claim 16, wherein the selected promotional offer is an offer for a patient co-pay discount for the selected pharmaceutical product.

19. The method of claim 15, further comprising:
responsive to the physician selection, displaying a session log of meetings between the selected physician and the pharmaceutical representative user, the session log identifying a pharmaceutical product from the pharmaceutical products list discussed with the selected physician at each meeting and the selected electronically stored content that the selected physician was granted access to at each meeting.

20. The method of claim 19, wherein the session log includes, for each meeting:
an indication of whether the selected physician was able to meet with the pharmaceutical representative user,
a duration of the meeting,
a rating of a level of access to a staff of the selected physician, and
a rating of a level of access to the selected physician.

21. The method of claim 20, further comprising:
averaging the rating of the level of access to the staff of the selected physician for a plurality of meetings between the selected physician and a plurality of pharmaceutical representative users in a plurality of session logs;
averaging the rating of the level of access to the selected physician for the plurality of meetings between the selected physician and the plurality of pharmaceutical representative users in the plurality of session logs;
designating the averaged ratings as overall engagement ratings for the staff of the selected physician and the selected physician accessible to the plurality of pharmaceutical representative users.

22. A non-transitory computer readable medium storing instructions that, when executed by a processing device, cause the processing device to:
authenticate a pharmaceutical representative user at a first computing system;
download, from a second computing system through a communications network, pharmaceutical-physician mappings for each physician assigned to the pharmaceutical representative user;
display a list of selectable physicians assigned to the pharmaceutical representative user;
responsive to a physician selection, display a list of selectable pharmaceutical products associated with the selected physician according to the downloaded pharmaceutical-physician mappings;
responsive to a pharmaceutical product selection, display a list of selectable electronically stored content associated with the pharmaceutical product selection;
responsive to an electronically stored content selection, grant the selected physician access to the selected electronically stored content at a third computing system used by the selected physician for accessing the electronically stored content selection; and
chronologically update a content stream viewable by the selected physician at the third computing system with an indication of the granting of access to the electronically stored content selection based on a time of the granting of said access to the selected electronically stored content.
